(19) United States
(12) Patent Application Publication
(10) Pub. No.: US 2018/0130002 A1
(43) Pub. Date: May 10, 2018

(54) REQUIREMENTS DETERMINATION

(71) Applicants: Paul Dekoekkoek, Minneapolis, MN (US); Mathijs Affourtit, Longmont, CO (US)

(72) Inventors: Paul Dekoekkoek, Minneapolis, MN (US); Mathijs Affourtit, Longmont, CO (US)

(21) Appl. No.: 15/566,422

(22) PCT Filed: Apr. 15, 2016
(86) PCT No.: PCT/IB2016/000558

§ 371 Date: Oct. 13, 2017

Related U.S. Application Data
(60) Provisional application No. 62/147,993, filed on Apr. 15, 2015.

(51) Int. Cl. G06Q 10/06; G06F 17/15; G06F 17/18

(52) U.S. Cl. CPC G06Q 10/06375; G06F 17/15; G06Q 10/06315; G06Q 10/063112; G06F 17/18

(57) ABSTRACT

A method of determining a requirements characterization profile for an entity, the method comprising the steps of: obtaining a predicted requirements characterisation profile for the entity, the profile comprising at least one characteristic having an initial predicted significance value and an initial confidence level for the initial predicted significance value; selecting in dependence on the confidence level at least one characteristic; obtaining an input from an external entity in respect of the characteristic; and determining, in dependence on the external input, a revised predicted significance value of the characteristic.

This invention relates to a method of determining the relative significance or importance of requirements or characteristics comprising a combination of interactive and predictive methods. In particular, the invention allows for key requirements to be determined and optionally ordered without the potential drawbacks of relying on either interactive or predictive methods alone. The invention may have particular relevance to a wide variety of fields.

The invention may find application in any field where an item is to be selected according to a list of requirements or a specification. For example, an item of hardware such as a bolt may potentially be sourced from one of many suppliers. Which bolt would be most suitable? The invention describes a method which could be used, allowing an initial specification for a bolt, generated according to a predictive model, to subsequently be refined according to real-world experiences, say provided by engineers with knowledge of which factors are most relevant. Importantly, the invention allows for this external input to be efficiently concentrated where it is most useful.

A specific example is provided relating to recruitment and job analysis, whereby a job is analysed into constituent components such as skills, competencies and other requirements, typically with the purpose of determining the best candidate for the job or for assessing an individual in a job.

Existing job analysis approaches tend to either start from an interactive ‘no information’ position or else rely heavily on prediction (see International Patent Application No. PCT/GB2012/052419, entitled “Requirements characterisation” or “JobMatch”). Neither method is optimal. When a volume of job analysis data is available there is no reason to start from zero. At the same time prediction alone will be limited in terms of accuracy and is dependent on the amount of information available.

In the following, a ‘competency framework’ such as UCF or its subset UCF20 is an example of a model comprising a plurality of characteristics which may be used to deconstruct and/or define an entity (be that a function, object, job etc) according to the relative significance or importance of its constituent parts.

The term ‘item’ as used herein refers to a question or statement used to determine from a user or addressee the perceived relative significance or importance of a characteristic, for example a competency. A questionnaire may therefore comprise a series of items being administered, ie. questions being asked.

Interactive Methods

In a ‘no information’ position no prior information is taken into account. Typically a consultant sits down with a client, discusses the job, identifies elements that are significant or important and translates these into competencies. This is typically referred to as a confirmatory job analysis since it aims to confirm what the consultant believes are the likely competencies needed. The next step is to administer a Job Analysis Questionnaire (JAQ). This questionnaire contains statements of behaviours that represent the various competencies. Clients typically respond on a rating scale ranging from ‘Not important at all’ to ‘Very important for the job’. Ratings could be on a five, seven or even 100 point scale. At the end of the questionnaire, the responses to the various behavioural statements are added up for each of the competencies measured, producing scores that represent the importance of each of the competencies. This process is repeated across multiple ‘raters’ and the final outcome is a list of competencies and their mean importance ratings. It should be noted that both at the stage where the consultant was discussing the job with the client and at the start of the job analysis questionnaire, no information from prior predictions techniques (such as JobMatch) is taken into account.

In another implementation of the job analysis questionnaire method the initial discussion is skipped and the process is started at the questionnaire phase. In that case the job analysis questionnaire is used in an exploratory way and all competencies are included in the questionnaire. For example if the competency model being used is the UCF20. (Universal Competency Framework, which comprise 20 competencies), items related to all 20 competencies would be administered. It should be noted again that no prior information is used. Administering items for all 20 competencies would lead to a lengthy questionnaire. Having multiple raters go through this process leads to more time spent on job analysis. Most organizations dislike lengthy surveys and having to administer many of them as this is considered non-productive time for the people responding to the survey.

Determining a job profile by administering a job analysis questionnaires leads to more accurate data. Numerous responses to behavioural statements are collected for each competency. This is done across a range of raters, resulting in a wealth of data collected specifically on the job that's being analysed, to base the final job profiles on. Multiple raters are used—these can include managers, job incumbents, job experts, HR staff members. Because the ratings come from such a large and diverse range of raters, a more comprehensive view of the job is created. As a result, the created job profiles are a more accurate representation of the job.

There are disadvantages to this approach as well. Multiple users spend up to an hour completing the job analysis questionnaire. This can add up to a large cost in terms of time spent.

Predictive Methods

Another way of doing job analysis is using prediction methodologies such as Job Match. This approach relies fully on prediction. The user enters information about the jobs in terms of job title and responses to a limited number of context questions, and this information is used to come up with a prediction. The user has the opportunity to overwrite the prediction the expert system generated, but no job analysis items are administered ie. there is no use of an interactive Job Analysis Questionnaire. It should be noted that this system is fully based on prediction and not on the administration of behavioural job analysis items.

The prediction method is fast and easy to use. The user essentially inputs a job title and moment later a job profile is presented. Limited information is collected from the user and no behavioural statements are presented. No job analysis items are presented. There are no multiple raters involved.

This method can lead to inaccuracies in the data, however. Perhaps the user has input a slightly different job title from the one that is relevant, or the prediction method is working less than optimally, because there is not enough previous data available to base the prediction on, or the data available is inaccurate. In short, prediction methods are fast, but the quality of the data can be limited. This requires more manual over-rides to “correct” inaccurate competencies suggested by the prediction algorithm.

As elaborated on above, current approaches rely either on collecting information from the user without taking into account any previous information, or else on estimating the significance or importance of competencies using prediction. Neither method is optimal. The present invention outlines a methodology for combining both approaches. It describes the concept and outlines mathematical procedures for combining predicted values with responses to job analysis items.

According to an aspect of the invention there is provided a method of determining the relative importance of item requirements or characteristics comprising a combination of interactive and predictive methods.

This invention makes it possible to combine the benefits of both approaches while reducing the drawbacks, ie. combining the speed of prediction with the accuracy of the full job analysis questionnaire.

According to an aspect of the invention there is provided a method of determining a requirements characterization profile for an entity, the method comprising the steps of: obtaining a predicted requirements characterisation profile for the entity, the profile comprising at least one characteristic having an initial predicted significance value and an initial confidence level for the initial predicted significance value; selecting in dependence on the confidence level at least one characteristic; obtaining an input from an external entity in respect of the characteristic; and determining, in dependence on the external input, a revised predicted significance value of the characteristic.

Preferably, the input from an external entity comprises a significance value.

Preferably, the input from an external entity comprises a confidence level for the significance value.

Preferably, a confidence level for the significance value obtained from the external entity is pre-determined.

Preferably, the revised prediction of the significance value of the characteristic comprises an inverse variance weighted mean calculation based on the significance values and confidence levels.

Preferably, the method further comprises determining, in dependence on the input from the external entity, a revised confidence level for the revised predicted significance value of the characteristic.

Preferably, the method further comprises determining whether the revised confidence level for the revised predicted significance value of the characteristic exceeds a threshold value; and, if not, obtaining a further input from an external entity in respect of the characteristic.

The revised confidence level may be determined by a calculation of variance of the inverse variance-weighted mean of significance values and confidence levels.

The revised confidence level may be determined by a calculation of weighted standard deviation of means of significance values and confidence levels.

Preferably, the method further comprises obtaining a further input from an external entity in respect of the characteristic until the number of inputs reaches a threshold value.

The further input from an external entity may comprise an input from a different external entity.

Preferably, the input from the external entity comprises a response to a questionnaire item.

Preferably, the confidence level for the significance value obtained from the external entity is based on correlations with earlier responses to a questionnaire item.

Preferably, the method further comprises linearly transforming at least one of the predicted significance value and the external input.

Preferably, the requirements characterisation profile comprises a plurality of characteristics, each comprising a predicted significance value for the characteristic and a confidence level for the predicted significance value.

Preferably, the method further comprises receiving classification parameters defining the requirement for an entity and obtaining the predicted requirements characterisation profile for the entity in dependence on the classification parameters.

The predicted requirements characterisation profile for the entity may be retrieved from a database of characterisation profiles.

The characteristics may be competencies.

Preferably, the confidence level of the predicted significance value is related the standard deviation of the distribution of significance values.

Preferably, the method further comprises generating a requirements characterization profile comprising a plurality of characteristics, each characteristic having a predicted significance value which exceeds a threshold value.

Preferably, the method further comprises outputting a requirements characterization profile for the entity.

Preferably, the method further comprises outputting the revised predicted significance values, and in dependence on any of claims 4 to 19, the revised confidence level for the revised predicted significance value of the characteristic, to a database for future use.

According to another aspect of the invention there is provided apparatus for carrying out any of the methods as herein described.

According to another aspect of the invention there is provided a computer program and a computer program product for carrying out any of the methods as herein described.

Also provided is a computer readable medium having stored thereon a program for carrying out any of the methods as herein described.

Also provided is a signal embodying a computer program for carrying out any of the methods as herein described.

Also provided is a computer product having an operating system which supports a computer program for carrying out the methods as herein described.

Also provided are methods and/or apparatus substantially as herein described with reference to the accompanying drawings.

A prediction is used as the initial input for the job analysis questionnaire. The prediction and associated confidence interval(s) are used to determine whether the prediction is sufficiently accurate or whether more information is required. Behavioural job analysis items are only administered for those competencies where additional information is required. This leads to a significantly abbreviated version of the job analysis questionnaire. No items are presented for competencies that are clearly important and the same applies to competencies that are clearly not important—both sets of competencies will not come up in the job analysis questionnaire. The questionnaire can be made adaptive. When the user responds in line with the prediction in the system, there is little need to administer numerous job analysis items. One or two items can be considered enough to reach sufficient confidence of the importance of the competency for the job. However if the responses by the user indicate that the user clearly has a different idea of how important a competency is for the job, the system can (and will) administer more items to ensure the importance of the competency can be correctly assessed and represented in the job profile. By combining the initial understanding of the job with a shortened job analysis questionnaire the process of job analysis can be made both substantially shorter and more accurate.

These approaches were previously not considered compatible. The output of the prediction method and job analysis questionnaire method can be very different. Both in terms of the scale they are on, how they are computed and what they represent. For example, the outcome of a prediction process can be based on a complex algorithm. Because the scores are derived differently they cannot readily be combined. It is for these reasons that the administration of a job analysis questionnaire and the prediction method have been treated as separate. Previously, there was no method to combine scores of both methods in a succinct process. Previously, administration of both methods would have more likely led to the inheritance of the disadvantages of both methodologies than the advantages. With this invention the situation improves dramatically. Taking into account not only the importance value of each but also the confidence interval of the data point (which can be a prediction, or a response to a behavioural job analysis item) the information can be combined to create a shorter questionnaire that adapts based on the users' responses and leads to a more accurate profile.

This invention comprises a methodology to combine predictions with responses to job analysis items. Results from these two methods have previously been challenging to combine. Through the use of this invention the advantages of both methods can be combined to create a more accurate, shorter way of doing job analysis.

The invention may comprise one or more of the following:
a computer-implemented system to analyze requirements, especially job or employment requirements, for example job characteristics, competencies and/or skills
a method of analyzing requirements, preferably job requirements, based on an initial prediction determined from a pre-existing title and/or one or more classifications retrieved from a database in combination with additional information obtained from external sources
a method of re-computing estimations of importance values and the associated confidence intervals to incorporate responses from the user
an iterative process that presents questions to the user, records the responses, and re-evaluates the current predictions and their confidence interval
a method of establishing whether predictions have reached sufficient levels of confidence
preferably, the prediction comprises at least one importance rating for a characteristic
the prediction may be associated with a confidence measure
preferably, at least some external information is determined from the response by an external entity to a query generated from the initial prediction and submitted to the external entity
the query may comprise a request to rank or assign an importance level to a characteristic
the query process may be adaptive
the number of queries submitted to the external entity may depend on the deviation of the responses from the initial prediction
additional queries may be submitted to the external entity when the deviation is high and/or confidence in the prediction is low
the outcome of the query process and/or analysis may be added to a master database for future re-use

Generally, the method is implemented on one or more computer servers. Suitable computer servers may run common operating systems such as the Windows systems provided by Microsoft Corporation, OS X provided by Apple, various Linux or Unix systems or any other suitable operating system. Suitable databases include ones based on SQL, for example as provided by Microsoft Corporation or those from Oracle or others. Embodiments of the invention may also be implemented in Microsoft Excel or similar business software. An optional web server provides remote access to the assessment system via a website or other remotely-accessible interface. Web interfaces and other code may be written in any suitable language including PHP and JavaScript. A Microsoft .Net based stack may be used.

Further features of the invention are characterised by the dependent claims, where appended.

The system and processes described may also interact with and make use of those described in the following documents, which are incorporated herein in their entirety by reference:
International Patent Application No. PCT/GB2012/052198, entitled “Analytics”, published as WO2013/034917, which describes apparatus for and a method of providing access to comparison metrics data relating to the comparison of a test or target group with a reference group, such as a benchmark group. An analytics system is also described. This has particular relevance in the sphere of talent management. In some embodiments, this allows for a user or organisation to determine or identify a parameter such as a “benchstrength” in talent acquisition (recruitment and selection), talent development and succession against a number of defined metrics through which actions to improve their talent management processes can be identified.
International Patent Application No. PCT/GB2012/052419, entitled “Requirements characterisation”, published as WO2013/045949 (the system described being at times referred to herein as “JobMatch”), which describes apparatus for and method of providing a requirements characterisation profile for an entity. In particular, this allows for 15 the translation of a generic requirements request into a specific requirements request. Described variants may also allow for translation between different models of requirements between different organisations, for the review and revision of the resulting requirements request, and may also provide recommendations of suitable assessments for determining whether the determined requirements are met.
International patent application PCT/GB2013/000170, entitled “Testing System”, published as WO2013/156746, which describes a testing system including apparatus for and methods of testing a subject according to a forced-choice scheme. In particular, a dynamic forced-choice testing system is described, based on Thurstonian 25 item-response theory. The system described therein is at times referred to herein as “Atlas”.
Co-pending International patent application PCT/IB2014/002382, entitled “Assessment system”, which describes in particular in particular to methods of and apparatus for producing a targeted assessment scheme comprising a battery of tests or assessments and based on a plurality of requirements. This is of particular (although not exclusive) relevance to the assessment of candidates for a job or a role dependent on preferred competencies and character traits. A method of and apparatus for creating a synthetic norm for a composite test, comprising a plurality of tests, by combining the scores and/or score distributions from the plurality of tests, is also described. The system described therein is at times referred to herein as “ASDS”.
U.S. Pat. No. 7,606,778, entitled “Electronic prediction system for assessing a suitability of job applicants for an employer”.
U.S. Pat. No. 8,086,558, entitled “Computer-implemented system for human resources management”.

The invention also provides a computer program and a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied as apparatus aspects, and vice versa.

Equally, the invention may comprise any feature as described, whether singly or in any appropriate combination. It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

The invention will now be described, purely by way of example, with reference to the accompanying drawings, in which:

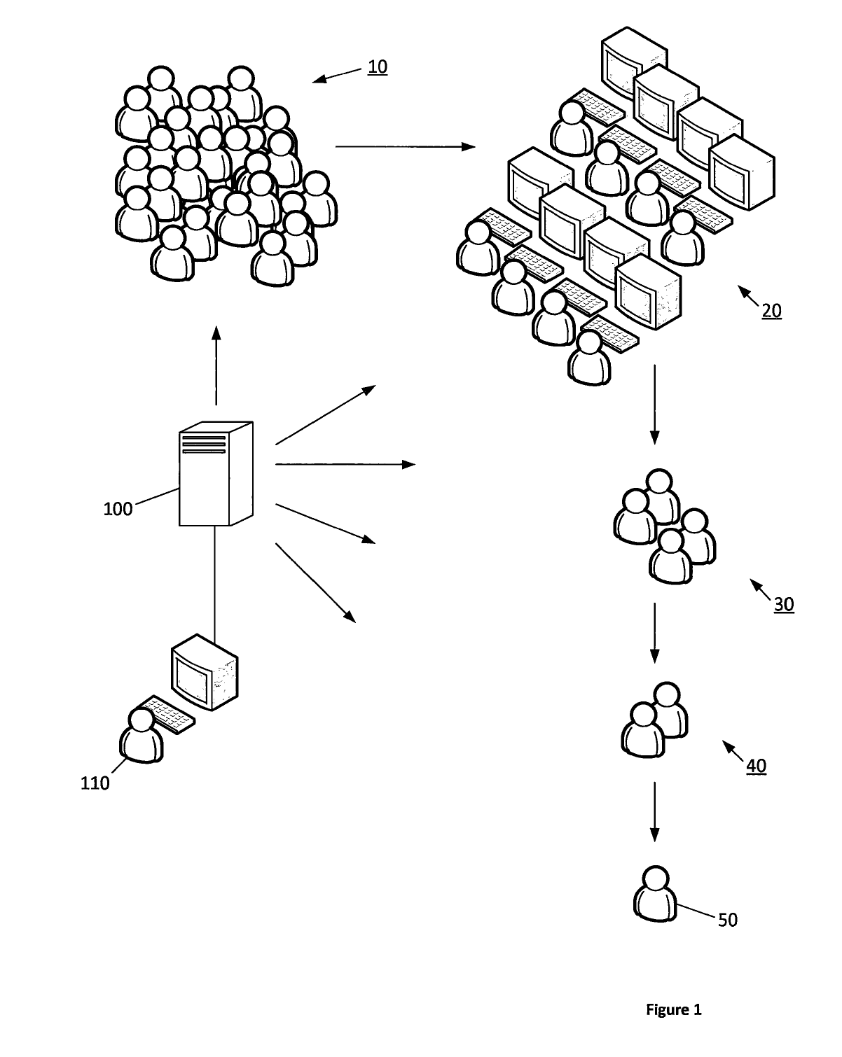

FIG. 1 shows an assessment process in overview;

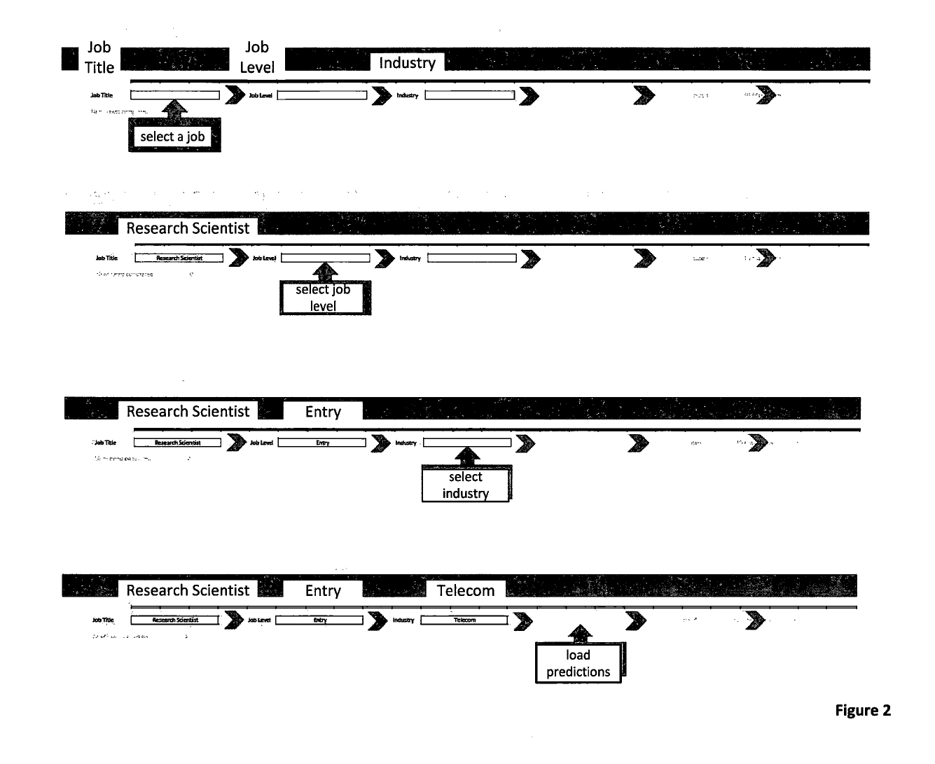

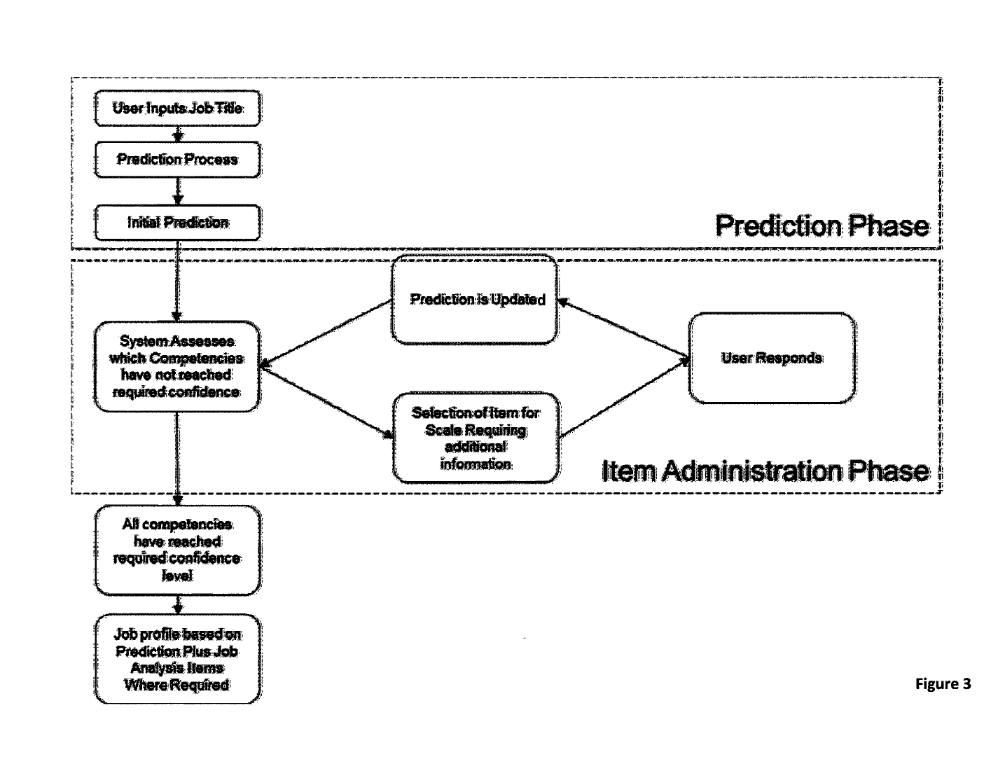

FIGS. 2 and 3 show stages of the assessment process;

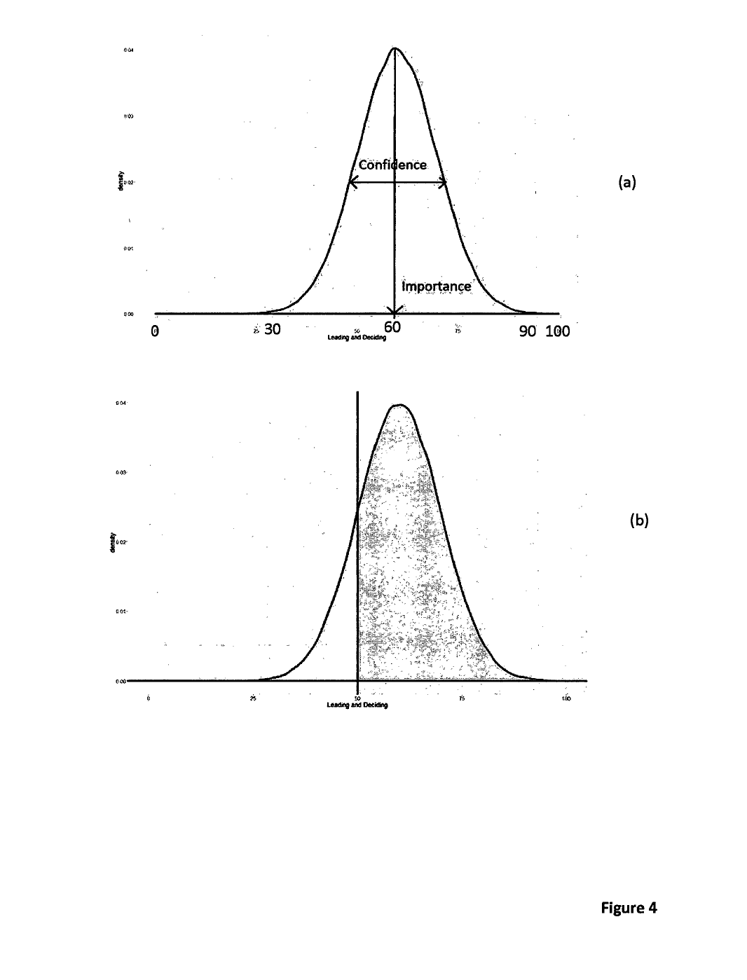

FIG. 4 shows a prediction with a confidence interval;

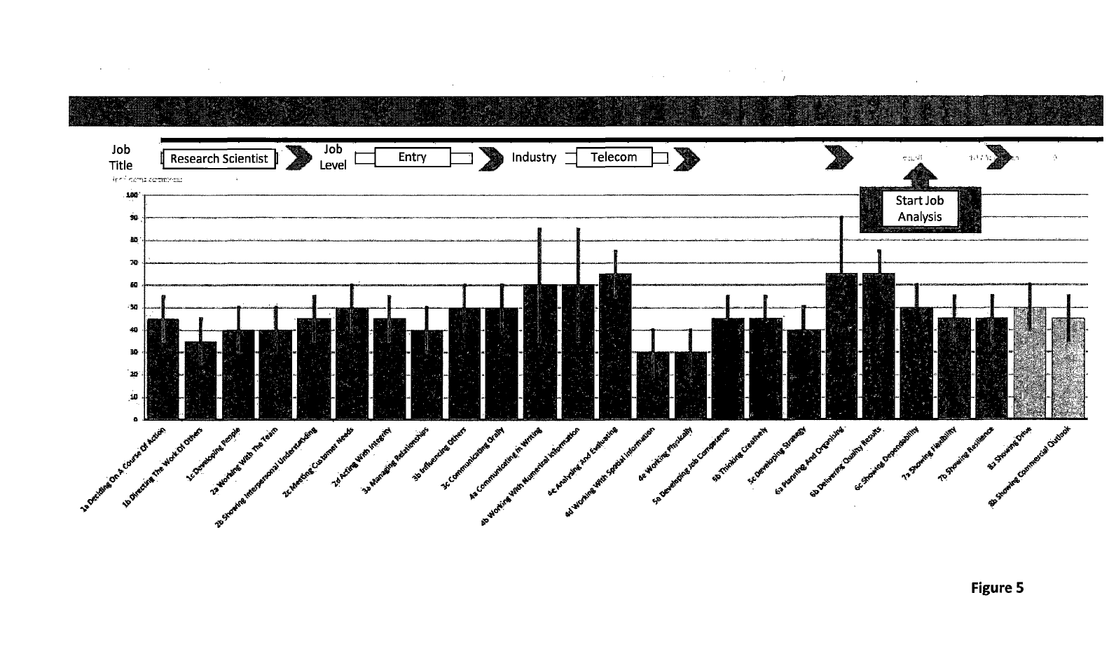

FIG. 5 shows an example job analysis prediction.

### OVERVIEW

FIG. 1 shows an assessment process in overview. The assessment of the suitably of a plurality of candidates 10 for a job or role is a process of several stages, typically involving initial screening 20, more focussed testing 30 (potentially a telephone interview) and finally a personal interview 40—before the successful candidate 50 is offered the job or role.

The design of the assessment process is therefore critical in ensuring the most suitable candidate is selected.

System 100 allows a user 110 to create a valid (as in, based on research evidence), multi-trait, multi-method candidate assessment for use in employment decisions, including personnel selection and promotion, by inputting information about job requirements (competency and skill requirements) and administration process (number of process steps, their order, languages to be used, form of reporting).

A more comprehensive approach involves taking what is known about a job roles based on job title and/or job classification (e.g. O*Net) and complementing this with additional information collected from stakeholders. The more information there is available from past data collection the less information needs to be gathered from the user as part of a job analysis questionnaire (JAQ). For the user this process would be seamless. The user would start by specifying the Job Title and/or job classification, following this they would be presented with JAQ items until sufficient information is collected.

The process starts with a prediction process which produces importance ratings for competencies related to the job. Each prediction has a measure of confidence associated with it.

FIGS. 2 and 3 show stages of the assessment process.

The process starts with retrieving an initial starting point job profile from a prediction methodology. JobMatch could be used or a different prediction method (e.g. competencies mapped to, generated, or acquired from any other internal or external model).

Typical stages as shown comprise:
1. Select a job eg. Research scientist
2. Select job level eg. Entry
3. Select industry eg. Telecoms
4. Load predictions

The job profile created as a result of the prediction methodology includes an importance rating and a confidence interval around the importance rating. A confidence interval gives an indication of how sure we are the prediction is correct or how much the true value could deviate from the prediction. The confidence interval may be represented as a standard deviation.

FIG. 4 shows a prediction with a confidence interval. In this case the predicted importance level for this competency is 60 on a 100 point scale. Also shown, the confidence interval is given by a standard deviation around the importance rating of 10. As can be seen, the shape and properties of the curve that defines the confidence interval would still allow for the possibility of the true importance score to range from a low value of approximately 30 and a high value of approximately 90. However, the further one gets away from the predicted mean importance value of 60, the less likely that value would be. The confidence interval typically requires a “degree” of confidence, say 95%. So, a 95% CI around a mean competency importance of 60 lets us know what the range of the true (population) value would be.

To derive this initial prediction the user enters basic information about the job, such as a job title and possibly answers to a small number of questions about the context of the job. This information is used to predict the importance of competencies on the job profile.

FIG. 5 shows an example job analysis prediction. A range of competencies are shown across the x-axis, each with an importance score out of 100 and associated confidence levels.

Next both importance ratings and their associated confidence levels are used to determine for which competencies more information is needed. At this point two cut-off values are relevant.
Minimum importance rating: This reflects the minimum importance rating the competency needs to have for it to be included in the final job profile as relevant for the job. All competencies with an importance rating above this value would be included in the profile. This could, for example, be 50 on a hundred point scale and would be specified a priori
Minimum confidence value (or maximum uncertainty): This value reflects the level of confidence (or the level of uncertainty) that is acceptable. The system will present the user with additional job analysis items until the required confidence level is reached. This could be a proportion or percentage. For example this value could be set to 95%, in which case, the importance rating needs to be within the 95% upper or lower bound of the CI for it to be included in the profile. Staying with the distribution in the previous example and setting the minimum importance rating at 50, all competencies with an importance value above 50 will be included in the final job profile. The Minimum confidence value will be set to 95%. In the graph (b) the highlighted area represents the probability that importance of this competency for this job is above the cut-off values of 50. In this example the probability that the importance value is above 50 is 84%. This value is lower than the required 95%. Therefore additional job analysis items will be presented to the user until the probability of the importance value being 50 or greater reaches 95%

The system uses the importance ratings and the confidence intervals for each of the competencies to determine for which competencies additional job analysis items need to be administered to reach the required confidence levels. Certain competencies will already, with sufficient confidence, fall above the cut off, while others will with sufficient confidence fall below the cut-off. For these competencies no job analysis items will be presented. (An exception can be made to this, if, for example, the user—or system administrator—has specified that a least a certain number of questions have to be administered per competency.)

Administering Items and Updating Predictions

Once the prediction stage is completed the user responds to additional JAQ items to complement the information available from the prediction.

This may be done, for example, by responding to a series of requests to rate the importance of a task (eg. “Write in a clear, logical and organised manner”) on a scale (eg. of 1-5).

Job analysis items will be presented for each competency where additional information is required. After each successive item and user response, the prediction is updated with the information received from the user. This information is used to update the predicted importance value and the associated confidence interval.

This process is adaptive in several ways:
The more the user agrees with the original prediction the fewer questions they would need to answer as part of the JAQ.
If the user responses do not align with the original prediction, additional questions would be asked until sufficient information is collected to get a good understanding of the job.
If there was low confidence in the original prediction (for example because not much information was available from previous job analysis studies) additional question would be asked.
If the job analysis is being done for a common job role, for which many job analysis studies have been completed, less information will need to be collected from the user.

This approach can be described as a computer adaptive approach to doing job analysis where past data is used as the starting point. The Tables below describes four situations or examples where the importance of a competency is rated.

First, in a simplified scheme:

| Situation A | | Situation B | | Situation C | | Situation D | |
|---|---|---|---|---|---|---|---|
| Prediction | 25 ± 2 | Prediction | 25 ± 20 | Prediction | 25 ± 20 | Prediction | 20 ± 20 |
| Item 1 | 25 | Item 1 | 25 | Item 1 | 70 | Item 1 | 70 |
| Item 2 | 26 | Item 2 | 26 | Item 2 | 60 | Item 2 | 20 |
| Item 3 | 24 | Item 3 | 24 | Item 3 | 65 | Item 3 | 70 |
| | | | | Item 4 | 70 | Item 4 | 20 |
| | | | | Item 5 | 60 | Item 5 | 70 |
| | | | | Item 6 | 65 | Item 6 | 20 |
| Conclusion | 25 ± 1 | Conclusion | 25 ± 3 | Conclusion | 63 ± 3 | Conclusion | 45 ± 15 |

Second, in a more detailed scheme:

| | | | | | |
|---|---|---|---|---|---|
| | | Updated | Updated | Probability | |
| Importance | SD | Prediction | SD | above 50 | Conclusion |

Example A

| | | | | | | |
|---|---|---|---|---|---|---|
| Prediction | 55 | 10 | 55 | 10 | 69.1% | Ask more questions |
| Item1 | 60 | 8 | 58 | 6 | 90.1% | Ask more questions |
| Item2 | 65 | 8 | 61 | 6 | 97.1% | Include |
| Item3 | | | | | | |
| Item4 | | | | | | |
| Item5 | | | | | | |
| Item6 | | | | | | |
| Item7 | | | | | | |
| Item8 | | | | | | |

Example B

| | | | | | | |
|---|---|---|---|---|---|---|
| Prediction | 55 | 40 | 55 | 40 | 55.0% | Ask more questions |
| Item1 | 60 | 8 | 60 | 8 | 89.4% | Ask more questions |
| Item2 | 55 | 8 | 57 | 6 | 90.6% | Ask more questions |
| Item3 | 65 | 8 | 60 | 6 | 96.0% | Include |
| Item4 | | | | | | |
| Item5 | | | | | | |
| Item6 | | | | | | |
| Item7 | | | | | | |
| Item8 | | | | | | |

Example C

| | | | | | | |
|---|---|---|---|---|---|---|
| Prediction | 25 | 15 | 25 | 15 | 4.8% | Don't include |
| Item1 | 65 | 8 | 56 | 7 | 80.8% | Ask more questions |
| Item2 | 55 | 8 | 56 | 6 | 84.1% | Ask more questions |
| Item3 | 65 | 8 | 58 | 6 | 93.3% | Ask more questions |
| Item4 | 55 | 8 | 58 | 6 | 91.3% | Ask more questions |
| Item5 | 60 | 8 | 58 | 6 | 92.4% | Ask more questions |
| Item6 | 70 | 8 | 60 | 6 | 96.2% | Include |
| Item7 | | | | | | |
| Item8 | | | | | | |

Example D

| | | | | | | |
|---|---|---|---|---|---|---|
| Prediction | 25 | 15 | 25 | 15 | 4.8% | Don't include |
| Item1 | 70 | 8 | 60 | 7 | 92.2% | Ask more questions |
| Item2 | 20 | 8 | 43 | 6 | 9.3% | Ask more questions |
| Item3 | 70 | 8 | 51 | 6 | 56.2% | Ask more questions |
| Item4 | 20 | 8 | 44 | 6 | 13.2% | Ask more questions |
| Item5 | 70 | 8 | 49 | 6 | 40.6% | Ask more questions |
| Item6 | 20 | 8 | 44 | 6 | 14.8% | Ask more questions |
| Item7 | 70 | 8 | 48 | 6 | 33.9% | Ask more questions |
| Item8 | 20 | 8 | 44 | 6 | 15.7% | Don't include |

Situation A: There is a prior prediction we are confident about. The responses collected from the user align with our prediction. Result: We can quickly stop asking questions about that competency.
Situation B: We have a prior prediction, but we aren't as confident as in Situation A. The responses we get from the user align with the prediction. Result: We can quickly stop asking questions about that competency.
Situation C: We have a prior prediction we aren't too confident about. The responses we get from the user don't align with our predictions. Result: We have to ask more questions and settle on an importance rating not aligned with our original prediction.
Situation D: We have a prior prediction we aren't too confident about. The responses we get from the user are inconsistent. In the end we stop asking questions because the maximum number of questions is reached. We end up with a prediction somewhere in the middle, but we still aren't too confident about the prediction.

The maximum number of question would be set by the user or an administrator and could vary depending on preference. Typically the maximum number of questions would be set equal to the number of questions that would be asked using a traditional job analysis questionnaire (without a prediction method). A reasonable value for the maximum number of questions could be between 4 and 8, though could be higher or lower depending on how many actual questions exist for a given competency or user preference.

If the maximum number of questions is reached, then whether the competency will be considered important for the job by comparing the two probabilities—first the probability that the competency is important and second the probability that the competency is not important based on the user-specified importance threshold value (e.g. 50). For example, if the probability that the competency is important is 55% and the probability that it is not important is 45% than the competency will be determined important for the job.

There are several statistical frameworks that could be used for updating the predictions, such as Item Response Theory (IRT), Bayesian statistics or a frequentist approach. The frequentist approach is discussed in more detail below.

Methods for re-computing the importance rating include: The inverse variance weighted mean, the inverse weighted standard deviation and the standard deviation of responses.

The importance rating—as in the mean of the prediction of the importance rating—is updated using the inverse variance weighted mean, which is described using the following formula:

$$\hat{y} = \frac{{\sum }_{i}^{ } {y}_{i} / {σ}_{i}^{2}}{{\sum }_{i}^{ } 1 / {σ}_{i}^{2}} .$$

where yᵢ represents the original prediction and user responses, ie. y₁ represents the importance rating derived from the prediction; y₂ represents the value of the first response; y₃ of the second response and so on.

In this way, unlimited responses can be added to the original prediction, making it more accurate as more responses are added, until the set confidence level is reached.

Likewise, sigma σᵢ represents the confidence level of the prediction and the responses, given by the standard deviation value—, ie. σ₁ represents the confidence level of the prediction; σ₂ represents the confidence level of the first response; σ₃ of the second response and so on.

One of the properties of an inverse-weighted mean is that predictions with lower confidence (i.e. a higher sigma value) have less influence on the final importance rating.

If the response scale of the job analysis items and prediction do not align the response goes through a linear transformation process where the response value on the original scale is associated with a value on the prediction scale. For example the values 1 through 5 would represent the value 10, 30, 50, 70, 90 on the hundred point prediction scale. If both scales are already on the same scale this transformation is not required.

The confidence of the prediction is evaluated using two measures.

Firstly, the variance of an inverse variance-weighted mean, which captures confidence based on the confidence levels of the original predictions and responses, ie. it reflects the confidence level of the updated prediction based on the confidence levels of the original prediction and the confidence levels of the responses. The variance of the inverse weighted mean is given by the following formula:

$${D}^{2} ( \hat{y} ) = \frac{1}{{\sum }_{i}^{ } 1 / {σ}_{i}^{2}} .$$

As before, sigma σᵢ represents the confidence of the prediction or response. Predictions with lower confidence have less impact on the final confidence level.

Secondly, the weighted standard deviation of means is used to capture inconsistent responding. The highest of these of two is compared to the confidence cut-off. If either of these exceeds a set cut-off value, additional questions would be asked. This process continues until the required level of confidence is reached or the maximum number of items for that competency has been reached.

As stated above, If the maximum number of questions is reached, then whether the competency is considered important for the job or not is based on comparing the probability of “important” vs. “not important” of the updated predicted mean importance value in relation to the importance threshold value. After each response, the predictions are updated with the new information and the system re-evaluates whether more items need to be administered for that scale to reach the minimum level of confidence specified. This makes the process adaptive. When the user response is consistent with the original prediction only a few job analysis items need to be administered. When the user response is inconsistent with the original prediction the confidence interval around the prediction would only slowly decrease and more items would be administered.

When a cut-off (predetermined threshold value) is reached for a competency, no more job analysis items will be presented to the user for that competency. When the cut-off is reached for all competencies the process is complete and the final competency profile can be stored and presented.

Associating a Response to a Job Analysis Item with a Confidence Interval

The formulas above can only be used when there is a confidence level associated with each response.

In some embodiments, a confidence level is associated with each item to which a user might respond. This will be pre-determined—either in the form of a user-specified value that is fixed and applied consistently across all possible items to be administered, or may be based on item-total correlations found using previous administration of the items. Ideally, data from previous administrations of the items would be used to improve accuracy.

In the situation where the confidence level is derived from item-total correlations, that data comes from the various items displayed during previous administrations of those items in a traditional job analysis questionnaire or during an item trialling phase, for example. When an item is administered as part of a job analysis questionnaire, the item is administered together with other items measuring the same competency. This is done across multiple users. When the users have completed the survey the responses for each of the competencies are summed, giving a total score for that competency. This total score can then be correlated with the responses of the items. The items that have a high correlation with the total score are considered more predictive items. Item with a low correlation with the total score are considered less predictive. How predictive an item is, determines its confidence interval. The confidence interval can be computed from the correlation using the formula below.

sd=\sqrt{(1−r²_{xy})σ_{y}²}

This value represents the standard deviation around a regression line defined by the correlation and the variance in response. It represents the confidence interval (when multiplied to represent the desired confidence interval percentage) associated with the item the user is responding to. This measure can also be used to select the most effective items first. The correlations have to be computed using data from past job analysis studies. However, once determined for each of the job analysis statements their values remain the same.

Further Features

When a job analysis study is complete, the results get added to a database based on Job Title and Occupation code, such that this information can be used for future predictions. Over time the system collects more information and prediction will become more accurate as a result increasing the efficiency of the process.

In addition to the updating the prediction, more advanced analysis could be done in the background. Consider for example a situation where a hierarchical competency framework is used and a user is responding inconsistently to the job analysis items. The system could do analysis one level down and look at responses associated with the sub elements of this competency. If there is consistent responding at the more detailed level, the system could, for example, suggest splitting up this competency in two separate elements, one of which is important and one of which is not.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in any claims are by way of illustration only and shall have no limiting effect on the scope of the claims.

The following items further describe the invention:
Item 1. A method of determining a requirements characterization profile for an entity, the method comprising the steps of:
   obtaining a predicted requirements characterisation profile for the entity, the profile comprising at least one characteristic having an initial predicted significance value and an initial confidence level for the initial predicted significance value;
   selecting in dependence on the confidence level at least one characteristic;
   obtaining an input from an external entity in respect of the characteristic; and
   determining, in dependence on the external input, a revised predicted significance value of the characteristic.
Item 2. A method according to item 1, wherein the input from an external entity comprises a significance value.
Item 3. A method according to item 2, wherein the input from an external entity comprises a confidence level for the significance value.
Item 4. A method according to item 3, wherein a confidence level for the significance value obtained from the external entity is pre-determined.
Item 5. A method according to any preceding item, wherein the revised prediction of the significance value of the characteristic comprises an inverse variance weighted mean calculation based on the significance values and confidence levels.
Item 6. A method according to any preceding item, further comprising:
   determining, in dependence on the input from the external entity, a revised confidence level for the revised predicted significance value of the characteristic.
Item 7. A method according to item 6, further comprising:
   determining whether the revised confidence level for the revised predicted
   significance value of the characteristic exceeds a threshold value; and, if not,
   obtaining a further input from an external entity in respect of the characteristic.
Item 8. A method according to item 6 or 7, wherein the revised confidence level is determined by a calculation of variance of the inverse variance-weighted mean of significance values and confidence levels.
Item 9. A method according to item 7 or 8, wherein the revised confidence level is determined by a calculation of weighted standard deviation of means of significance values and confidence levels.
Item 10. A method according to any of items 7 to 9, further comprising:
   obtaining a further input from an external entity in respect of the characteristic until the number of inputs reaches a threshold value.
Item 11. A method according to any of items 7 to 10, wherein the further input from an external entity comprises an input from a different external entity.
Item 12. A method according to any preceding item, wherein the input from the external entity comprises a response to a questionnaire item.
Item 13. A method according to item 12, wherein the confidence level for the significance value obtained from the external entity is based on correlations with earlier responses to a questionnaire item.
Item 14. A method according to any preceding item, further comprising linearly transforming at least one of the predicted significance value and the external input.
Item 15. A method according to any preceding item, wherein the requirements characterisation profile comprises a plurality of characteristics, each comprising a predicted significance value for the characteristic and a confidence level for the predicted significance value.
Item 16. A method according to any preceding item, further comprising receiving classification parameters defining the requirement for an entity and obtaining the predicted requirements characterisation profile for the entity in dependence on the classification parameters.
Item 17. A method according to any preceding item, wherein the predicted requirements characterisation profile for the entity is retrieved from a database of characterisation profiles.
Item 18. A method according to any preceding item wherein the characteristics are competencies.
Item 19. A method according to any preceding item wherein the confidence level of the predicted significance value is related to the standard deviation of the distribution of significance values.
Item 20. A method according to any preceding item, further comprising generating a requirements characterization profile comprising a plurality of characteristics, each characteristic having a predicted significance value which exceeds a threshold value.
Item 21. A method according to any preceding item, further comprising outputting a requirements characterization profile for the entity, preferably also using the output characterization profile to select the best-matching entity from a plurality of potentially suitable entitles.
Item 22. A method according to any preceding item, further comprising outputting the revised predicted significance values, and in dependence on any of items 4 to 19, the revised confidence level for the revised predicted significance value of the characteristic, to a database for future use.
Item 23. Apparatus for carrying out the method of any preceding item.
Item 24. Apparatus for determining a requirements characterization profile for an entity, the apparatus comprising:
   means for obtaining a predicted requirements characterisation profile for the entity, the profile comprising at least one characteristic having an initial predicted significance value and an initial confidence level for the initial predicted significance value;
   means for selecting in dependence on the confidence level at least one characteristic;
   means for obtaining an input from an external entity in respect of the characteristic; and
   means for determining, in dependence on the external input, a revised predicted significance value of the characteristic.
Item 25. Apparatus according to preceding item 24, further comprising:
   means for determining, in dependence on the input from the external entity, a revised confidence level for the revised predicted significance value of the characteristic.
Item 26. Apparatus according to item 25, further comprising:
   means for determining whether the revised confidence level for the revised predicted significance value of the characteristic exceeds a threshold value; and
   means for obtaining a further input from an external entity in respect of the characteristic.
Item 27. A computer program and a computer program product for carrying out any of the methods of item 1 to 22.
Item 28. A computer readable medium having stored thereon a program for carrying out any of the methods of item 1 to 22.
Item 29. A signal embodying a computer program for carrying out any of the methods of item 1 to 22.
Item 30. A computer product having an operating system which supports a computer program for carrying out the methods of item 1 to 22.
Item 31. Methods and/or apparatus substantially as herein described with reference to the accompanying drawings.

1. A method of determining a requirements characterization profile for an entity, the method comprising the steps of:
obtaining a predicted requirements characterisation profile for the entity, the profile comprising at least one characteristic having an initial predicted significance value and an initial confidence level for the initial predicted significance value;
selecting in dependence on the confidence level at least one characteristic;
obtaining an input from an external entity in respect of the characteristic; and
determining, in dependence on the external input, a revised predicted significance value of the characteristic.

2.-31. (canceled)
